(19) United States
(12) Patent Application Publication
(10) Pub. No.: US 2006/0146555 A1
(43) Pub. Date: Jul. 6, 2006

(54) Vehicular lamp

(75) Inventor: Tetsuaki Inaba, Shizuoka (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/297,069

(22) Filed: Dec. 8, 2005

(30) Foreign Application Priority Data
Dec. 10, 2004 (JP) P. 2004-358514

(51) Int. Cl. B60Q 1/26

(52) U.S. Cl. 362/494; 340/475

(57) ABSTRACT

A vehicular lamp installed in a sideview mirror housing 10 that has a laterally extending opening 12. The vehicular lamp has a horizontally curved shape and is installed in the housing 10 such that the entirety of its front lens 24 is substantially flush with and exposed through the opening 12. An LED 26 and a light guide inner lens 27 are installed inside a curved and laterally elongated lamp chamber space S which is defined by the lamp body 22 and the front lens 24. The LED 26 for illuminating the entire light guide inner lens is disposed on a curved wrap-around side of the lamp chamber space S so as to face the vehicle forward direction, and another LED 29 is provided in the vehicle width outward direction so that it distributes emitted light in a predetermined direction directly or via a reflector 34.

### BACKGROUND OF THE INVENTION

1. Field of the Invention

The present invention relates to a vehicular lamp such as a side turn signal lamp and a daytime running lamp integrated in a sideview mirror of an automobile.

2. Description of the Related Art

Japanese Patent Application Laid-Open (Kokai) No. 2002-79885 discloses a vehicular lamp integrated in a sideview mirror of an automobile. In this related art, a mirror housing 1, as seen from FIG. 6, includes therein a sideview mirror main body (not shown); and a laterally extending opening la is formed on the side part of the mirror housing 1 that extends toward the back of a vehicle body; and a vehicular lamp (a side turn signal lamp) 3 is fixedly mounted to the back surface of the rim of the opening 1a so that the front lens 4 of the lamp 3 is exposed through the opening 1a of the mirror housing 1. The front lens 4 and a lamp body 5 define a lamp chamber space of the lamp 3; and LEDs (light emitting diodes) 6 that distribute light toward the side of the vehicle are provided on a wrap-around side of the lamp chamber space (on an end side of the wrap-around side of the lamp chamber space in the vehicle width outward direction).

As shown in FIG. 7, the mirror housing 1 disclosed in the U.S. Pat. Nos. 6,769,798 and 6,880,960 includes therein a sideview mirror main body (not shown); and a laterally extending opening la is formed in the mirror housing 1 so that it is on the lateral side of the mirror housing 1 and extends toward the back of the vehicle body. A vehicular lamp 3 is fixedly mounted to the back of the rim of the opening 1a so that the front lens 4 of the lamp 3 is exposed through the opening 1a. The front lens 4 and a lamp body 5 define a lamp chamber space of the lamp 3; and front LEDs 6a and a side LED 6b are installed on the side opposite from a wrap-around side of the lamp chamber space (on an end side opposite the wrap-around side of the lamp chamber space in the vehicle width outward direction). The front LEDs 6a illuminate an area of the front lens 4 that faces the front of the vehicle, and the side LED 6b illuminates a wrap-around side area of the front lens 4, which serves as a light guide lens.

The structure of the above-described first related art, the Japanese Patent Application Laid-Open (Kokai) No. 2002-79885, has the advantage of suppressing interference between the movable mirror main body and the lamp 3. This is achieved by providing the LEDs 6 on the wrap-around side of the lamp chamber space and forming the lamp 3 in a thin shape (reducing the amount the lamp body 5 protrudes inside the mirror housing 1). However, the resulting light emission area of the lamp 3 (or the front lens 4) is small, which in turn worsens the visibility of the lamp when it is lit.

The structure of the second related art, the U.S. Pat. Nos. 6,769,798; and, 6,880,960, possesses excellent lamp visibility when it is lit because the entire front lens 4 emits the light. However, if the sideview mirror is viewed from the front of the vehicle when the lamp is unlit, all the LEDs 6a are visible through the front lens 4, and the LEDs 6a detract from the overall appearance. Also, providing the LEDs 6a in an area of the lamp chamber space that faces the front of the vehicle makes the lamp 3 have a large depth dimension (a large amount of protrusion into the mirror housing 1 of the lamp body 5), and this in turn restricts the design layout (arrangement) of the movable mirror main body in the mirror housing 1.

### BRIEF SUMMARY OF THE INVENTION

In view of the foregoing issues with the related art, it is an object of the present invention to provide a vehicular lamp that is thin, has excellent visibility when it is lit, and has a good overall unlit appearance.

The above oject is accomplished by a unique structure of the present invention for a vehicular lamp adapted to be installed in a mirror housing of a vehicle, wherein the mirror housing includes therein a sideview mirror main body and has a laterally extending opening formed on an end side, which wraps around toward a vehicle backward direction, of the outer wall of the mirror housing; and

a lamp main body of the vehicular lamp is formed by a lamp body and a front lens, the lamp main body having an overall curved shape that generally follows the curved opening of the mirror housing, and the front lens being substantially flush with and exposed through the opening of the mirror housing; and wherein

the vehicular lamp has a curved, horizontally elongated lamp chamber space which is defined by the lamp body and front lens and is provided therein with a light source for the vehicular lamp and a light guide inner lens disposed along the front lens which planarly emits light; and in the present invention, the light source comprises:

a first LED (light emitting diode) provided to face the vehicle forward direction on the curved wrap-around side of the lamp chamber space and to face the incident light end portion of the light guide inner lens, the wrap-around side corresponding to the vehicle width outward direction; and

a second LED disposed adjacent to the first LED in the vehicle width outward direction for distributing light in a predetermined direction directly or via a reflector.

In the above structure according to the first aspect of the present inveniton, the overall shape of the lamp main body (the horizontally long lamp chamber space formed by the lamp body and the front lens) takes a curved shape that follows the shape of the opening of the mirror housing outer wall, and the light guide inner lens disposed in the lamp chamber space also has a shape formed along the front lens. Furthermore, the first LED illuminating the entirety of the light guide inner lens is disposed to face the vehicle forward direction on the curved wrap-around side of the lamp chamber space that corresponds to a vehicle width outward direction, and the second LED is provided adjacent to the first LED in the vehicle width outward direction. Accordingly, though the dimension of the lamp is large in the vehicle longitudinal direction on the curved wrap-around side that corresponds to the vehicle width outward direction of the lamp main body (lamp chamber space), the thickness (depth) in the area that faces the vehicle backward (forward) direction of the lamp main body (lamp chamber space) is thin (small), and the lamp body does not considerably expand toward the vehicle backward side (into the mirror housing).

In the present invention, the second LED is additionally provided; and light emission of the second LED is distributed in a predetermined direction directly and by the reflector, and the amount of lamp light distribution and the visibility of the lamp when it is lit both increase compared to the structure in which the first LED illuminates the entire light guide inner lens. In other words, the direct light emission and light distribution in a predetermined direction via the reflector from the second LED has a stronger orientation characteristic (directionality) than the light distribution of light emitted from the first LED (light emitted from the entirety of the light guide inner lens); accordingly, the second LED provides a conspicuous increase in the amount of light distribution and visibility.

In the present invention, light emitted from the second LED can be distributed in the same direction as the light distribution of the light guide inner lens, whose entire surface is illuminated by the first LED, and this structure increases the light-emitting surface area of the front lens and the amount of lamp light distribution, and it also increases the visibility of the lamp. On the other hand, light emitted from the second LED can be distributed in a direction different from the light distribution of the light guide inner lens in the present invention; and this structure greatly expands the light distribution area, and it additionally increases the light-emitting surface area of the front lens and the amount of lamp light distribution. The visibility of the lamp is thus further increased.

In the latter structure in which light emitted from the second LED is distributed in a direction different from the light distribution of the light guide inner lens, such a structure can be provided that a first lamp is provided with the light guide inner lens, whose entire surface is illuminated by the first LED, while light distribution generated by light emitted from the second LED (light distribution in a direction different from the light distribution of the first lamp) can function as a second lamp (another lamp different from the first lamp).

In addition, in the present invention, (the incident light end portion of) the light guide inner lens can be disposed in front of the first LED that faces the vehicle forward direction. In this structure, the first LED is not visible through the front lens when the sideview mirror is viewed from the vehicle forward direction.

Furthermore, in the second aspect of the present invention, the first and second light emission areas of the front lens can be structured so that they illuminate in different colors; and this is done by using first and second LEDs which differs from each other in emitting light, by using a colored filter which is disposed in front of at least one of the first and second LEDs, by using a light guide inner lens which has predetermined different colors, or by using a front lens which has mutually different colors.

In the above structure of the present invention, the first and second light emission areas of the front lens corresponding to the first and second LEDs emit light that is mutually different in color by any of the following ways: using LEDs that emit different color lights for the first and second LEDs, interposing a colored filter in front of at least one of the first and second LEDs, using a light guide inner lens of predetermined different colors, and using a front lens having different colors. In other words, according to the present invention, the first and second light emission areas of the front lens function as two different lamps that emit light of different colors.

Furthermore, in the third aspect of the present invention, the vehicular lamp is provided with a partition disposed between the first and second LEDs in the lamp chamber space for preventing the mixing of colors of emitted light in the first and second light emission areas of the front lens.

In this structure, the partition disposed between the first and second LEDs (the partition being formed on the lamp body and/or front lens, thus defining and separating the lamp chamber space into right and left portions) blocks light from the first LED heading toward the second light emission area of the front lens and vice versa, thus preventing the color mixing of light emitted from the first and second light emission areas of the front lens.

In the vehicular lamp of the fourth aspect of the present invention, a vertical groove, which extends in the vertical direction with respect to the partition, is formed between the first and second light emission areas on the front lens surface; and in addition, a vertical rib, which is joined to the vertical groove, is provided on the opening of the outer wall of the mirror housing and vertically traverses the opening.

In this structure, when the lamp is mounted on the outer wall of the mirror housing, the entire front lens surface is substantially flush with and exposed through the opening of the outer wall, and the vertical rib vertically traversing the opening is engaged with the vertical groove of the front lens. In other words, the opening of the mirror housing outer wall is laterally separated into the first and second openings by the vertical rib, and the entirety of the first and second light emission areas of the front lens of the lamp are respectively fitted in the thus laterally separated first and second openings of the mirror housing so that the first and second light emission areas are substantially flush with and exposed through the first and second openings. Accordingly, the first and second light emission areas of the front lens of the lamp are laterally separated and isolated by the vertical rib of the mirror housing, which is part of the mirror housing outer wall, and the first and second light emission areas provides a sophisticated appearance.

The above-described vertical rib extending along the boundary between the first and second light emission areas of the front lens of the lamp blocks the mixed colored light radiating from the boundary. The vertical rib thus has an additional effect that the vertical rib makes the color of light emitted from the first and second light emission areas of the front lens more distinct.

As seen from the above, according to the first aspect of the present invention, the depth of the area of the lamp main body (lamp chamber space) that faces the vehicle backward direction is small and thin, so that interference with the mirror main body in the mirror housing is prevented, increasing the design freedom of the sideview mirror component members accordingly.

Furthermore, with an addition of the light distribution with a strong orientation characteristic from the second LED, the light-emitting surface area of the front lens naturally increases, and the amount of lamp light distribution and expansion of the light distribution area is also considerably increased. The visibility of the lamp when it is lit is thus further enhanced.

Since the first LED is behind the light guide inner lens and not visible through the front lens, the overall appearance of the lamp from the vehicle forward direction when it is unlit improves.

According to the second aspect of the present invention, the first and second light emission areas of the front lens of the lamp integrated into a sideview mirror body are able to perform two different functions by the emission of light of different colors. Thus, the lamp has an entirely novel configuration and makes a vehicle with the lamp distinguishable from other vehicles.

According to the third aspect of the present invention, the first and second light emission areas of the front lens of the lamp emit distinct light of predetermined colors without being mixed. Therefore, the lamp has, when it is unlit, has an improved visibility.

According to the fourth aspect of the present invention, the first and second light emission areas of the front lens of the lamp that are exposed through the openings of the sideview mirror housing are laterally separated by the vertical rib which is a part of the outer wall of the mirror housing. Thus, the lamp has an entirely novel configuration and can be used for clearly distinguishing the vehicle with the lamp from others.

In addition, the effect of blocking the mixing of the colored light by the vertical rib extending along the boundary between the first and second light emission areas of the front lens makes the emission of the respective light colors from the first and second light emission areas of the front lens more distinct, thus further improving the visibility of the lamp when it is lit.

### BRIEF DESCRIPTION OF THE SEVERAL VIEWS OF THE DRAWINGS

FIG. 1 is a front elevational view of a marker lamp according to the first embodiment of the present invention;

FIG. 2 is a horizontal cross-sectional view of the marker lamp taken along the line II-II in FIG. 1;

FIG. 3 is a horizontal cross-sectional view of a marker lamp according to the second embodiment of the present invention;

FIG. 4 is a horizontal cross-sectional view of a marker lamp according to the third embodiment of the present invention;

FIG. 5 is a horizontal cross-sectional view of a marker lamp according to the fourth embodiment of the present invention;

FIG. 6 is a horizontal cross-sectional view of a side turn signal lamp of the first related art; and

FIG. 7 is a horizontal cross-sectional view of the vehicular lamp of the second related art.

### DETAILED DESCRIPTION OF THE INVENTION

Embodiments of the present invention will be described below in detail.

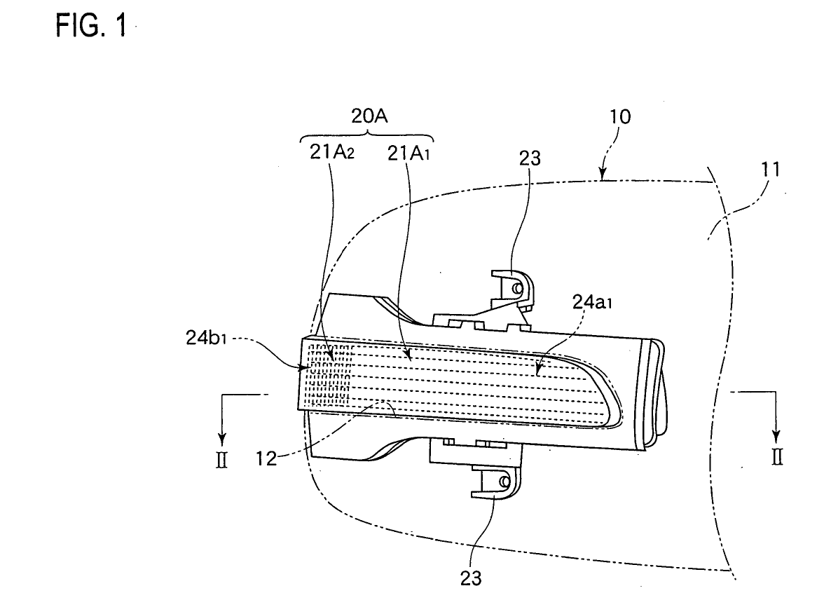

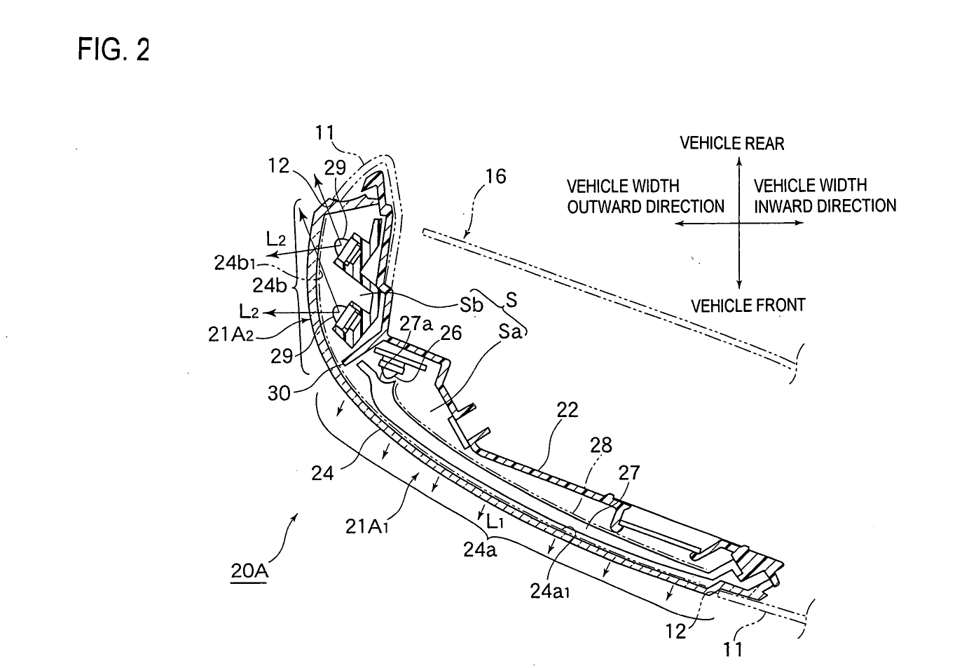

In FIGS. 1 and 2, the reference numeral 10 denotes a sideview mirror housing made of, for instance, synthetic resin, and it contains therein a sideview mirror main body 16 (see FIG. 2). The mirror housing 10 has a laterally extending opening 12 formed toward the vehicle width outward direction (left side in FIGS. 1 and 2) of the curved outer wall 11 of the mirror housing 10.

The reference numeral 20A is a horizontally long integrated side turn signal lamp/daytime running lamp (simply called “multi-functional lamp”), which integrates a daytime running lamp 21A₁ and a side turn signal lamp 21A₂. As seen from FIG. 2, the overall shape of the multi-functional lamp 20A is formed by a lamp body 22 and a front lens 24. The multi-functional lamp 20A has a curved shape that generally follows the opening 12 of the curved housing outer wall 11 of the mirror housing 10, and it is fixedly installed on the inner side of the opening 12. Furthermore, the entirety of its style surface (front surface) of the front lens 24 of the multi-functional lamp 20A is substantially flush with and exposed through the opening 12 of the outer wall 11.

The reference numeral 23 is an installation bracket formed with a mounting hole. The installation bracket 23 is fixed on the lamp body 22 of the multi-functional lamp 20A. More specifically, the installation bracket 23 is attached to the inner side of the outer wall 11 of the mirror housing 10 by a fastening screw (not shown).

As seen from FIG. 2, the multi-functional lamp 20A has a curved lamp chamber space S that is laterally slender and is defined by the lamp body 22 and the transparent front lens 24. The lamp body 22 is provided with a partition 30 that extends toward the inner side of the lamp body 22 and vertically traverses the laterally elongated lamp chamber space S so that it separates the lamp chamber space S into a first lamp chamber space Sa and a second lamp chamber space Sb. The first lamp chamber space Sa is for the daytime running lamp 21A₁ and located toward the vehicle width inward direction, and the second lamp chamber space Sb is for the side turn signal lamp 21A₂ and located toward the vehicle width outward direction.

Provided in the first lamp chamber space Sa are a first LED (light emitting diode) 26 and a transparent light guide inner lens 27. The first LED 26 emits white light serving as a light source for a plurality of (for example, three) daytime running lamps 21A₁ arranged at regular intervals in the vertical direction to face the front of the vehicle. The transparent light guide inner lens 27 that planarly emits light has an incident light end portion 27a that faces the LED 26, and it is disposed along the front lens 24.

The light guide inner lens 27 has front and back surfaces that completely reflect and guide incident light up to another end of the inner lens 27 which is the opposite end from the incident light end portion 27a. The light guide inner lens 27 is formed with stipples 28 on its back surface. The stipples 28 are provided, at a regular vertical and horizontal pitch, on almost the entire back surface of the light guide inner lens 27. The stipples 28 illuminate the surface of the light guide inner lens 27. In other words, white light of the LED 26 that is incident to the light guide inner lens 27 from the incident light end portion 27a is internally reflected repeatedly and guided over the entire light guide inner lens 27, and it is reflected in the vehicle forward direction at positions of the stipples 28; as a result, the entire surface of the light guide inner lens 27 planarly emits light, and an entire light emission area 24a that corresponds to the first lamp chamber space Sa of the front lens 24 evenly emits white light. The reference numeral L₁ in FIG. 2 indicates the faint light distribution of the daytime running lamp 21A₁.

As seen from the above, the daytime running lamp 21A₁ that distributes white light in the vehicle forward direction is formed by the lamp body 22, the partition 30, the light emission area 24a of the front lens 24, the LED 26, and the light guide inner lens 27.

Since the LED 26 is hidden behind (the incident light end portion 27a of) the light guide inner lens 27 and not visible through the front lens 24, the lamp 20A has a good overall appearance when seen from the vehicle front side when it is not lit.

The back surface of the light guide inner lens 27 is aluminized except for the incident light end portion 27a. This is performed so that the entire lamp chamber interior appears to be mirrored and to ensure that the area behind the light guide inner lens 27 is not visible therethrough.

Furthermore, cylindrical steps 24a₁ that extend laterally are formed on the back surface of the light emission area 24a corresponding to the first lamp chamber space Sa of the front lens 24 so that the cylindrical steps 24a₁ are in a continuous fashion in the up-down direction. The cylindrical steps 24a₁ make the interior of the lamp chamber invisible through the front lens 24.

In the second lamp chamber space Sb, a pair of second LEDs 29 are installed adjacent to each other in the vehicle longitudinal direction in a plurality of (for example, three) steps in the vertical direction. The LEDs 29 emit amber light serving as a light source for the side turn signal lamp 21A₂. Both LEDs 29 are provided so that they face the vehicle obliquely backward direction. Light emitted from the LEDs 29 has a strong orientation characteristic (directionality) and illuminates the light emission area 24b that faces the lamp chamber space Sb of the front lens 24 in amber color, and the light from the LEDs 29 is then distributed in the vehicle obliquely backward direction. The reference numeral L₂ in FIG. 2 illustrates the light distribution with a strong orientation characteristic of the side turn signal lamp 21A₂.

As seen from the above, the side turn signal lamp 21A₂ that distributes flashing amber light in the vehicle obliquely backward direction is formed by the lamp body 22, the partition 30, the light emission area 24b of the front lens 24, and the LEDs 29.

Directly incident steps 24b₁ are formed on the back surface of the light emission area 24b that faces the second lamp chamber space Sb of the front lens 24. The directly incident steps 24b₁ make the interior of the lamp chamber not through the front lens 24.

In addition, the partition 30, which defines and separates the lamp chamber space S into the right and left portions, blocks the light that is white light emitted from the LED 26 and advances toward the adjacent second lamp chamber space Sb and the light that is amber light emitted from the LED 29 and advances toward the adjacent first lamp chamber space Sa. Thus, the partition 30 functions as a light shield for preventing mixing of color of lights and ensures that emitted amber and white lights do not mix in the boundary area between the light emission areas 24a and 24b of the front lens 24.

The side turn signal lamp 21A₂ flashes in association with a turn signal lamp. The daytime running lamp 21A₁ turns ON when an engine switch of the vehicle is turned ON. Turning OFF of the engine switch or turning ON of a clearance lamp switch turns OFF the daytime running lamp 21A₁. The daytime running lamp 21A₁ can be used as a fashion lamp during nighttime running by way of designing the daytime running lamp 21A₁ so that it stays lit as long as the engine switch is not turned OFF, regardless of whether the clearance lamp switch is turned ON.

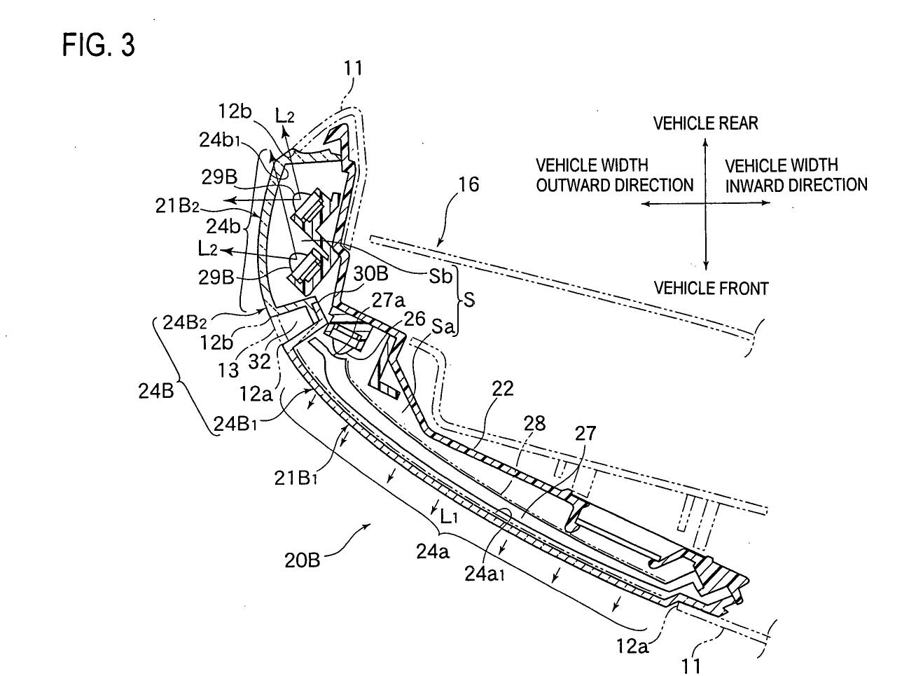

FIG. 3 shows, in cross-section, a marker lamp according to the second embodiment of the present invention.

In the first embodiment described above, the entire front lens 24 is transparent. However, in the second embodiment, the front lens 24B of the multi-functional lamp 20B is a two-color lens comprised of a transparent portion 24B₁ making a daytime running lamp 24B₁ and an amber-colored portion 24B₂ making a side turn signal lamp 21B₂. Accordingly, it is possible to use LED's that emit white light for the LED 26 serving as the light source for the daytime running lamp 21B₁ and for the LED 29B serving as the light source for the side turn signal lamp 21B₂.

In the first embodiment, as seen from FIG. 2, the partition 30 is formed on the lamp body 22. In the multi-functional lamp 20B of the second embodiment shown in FIG. 3, the front lens 24B is formed with a partition 30B (at a portion of the front lens 24B combining the transparent portion 24B₁and the amber-colored portion 24B₂), so that the partition 30B separates and defines the first and second lamp chamber spaces Sa and Sb. The partition 30B prevents the mixing of light emitted from the light emission areas 24a and 24b that correspond to the first and second lamp chamber spaces Sa and Sb of the front lens 24B.

The partition 30B located between the light emission areas 24a and 24b of the front lens 24B defines a vertical groove 32 that has a predetermined width and extends in the vertical direction. The housing outer wall 11 (or the outer wall 11 of the mirror housing 10) is formed with openings 12a and 12b so as to positionally correspond, respectively, to the light emission areas 24a and 24b of the front lens 24B. The openings 12a and 12b are separated by a vertical rib 13 that extends in the vertical direction (in other words, the opening 12 shown in the first embodiment is separated into the laterally adjacent first and second openings 12a and 12b by the vertical rib 13). The width of the vertical rib 13 conforms to the width of the vertical groove 32.

Accordingly, when the multi-functional lamp 20B is installed in the housing outer wall 11, the entirety of the light emission areas 24a and 24b of the front lens 24b are respectively fitted in the openings 12a and 12b so that the light emission areas 24a and 24b are substantially flush with and exposed through the openings 12a and 12b, and the vertical rib 13 is engaged with the vertical groove 32 of the front lens 24B. The vertical rib 13 that extends along the boundary between the light emission areas 24a and 24b of the front lens 24B blocks the mixed amber and white light emitted from the boundary and makes the respective light emitted from the light emission areas 24a and 24b of the front lens 24B more distinct.

As seen from the above, in the second embodiment, the partition 30B and the vertical rib 13 has a color mixing prevention effect. As a result, the color of light emitted from the light emission areas 24a and 24b of the front lens 24B is more distinct, and the lamp has excellent visibility when it is lit.

In addition, in the second embodiment shown in FIG. 3, the light emission areas 24a and 24b of the front lens 24B are respectively exposed through the openings 12a and 12b of the mirror housing outer wall 11, and the light emission areas 24a and 24b are laterally isolated and separated by the vertical rib 13 which is a part of the mirror housing outer wall 11. Accordingly, a completely novel configuration is achieved, making it possible to clearly distinguish the vehicle with the lamp from other vehicles.

The above-described second embodiment is identical to the first embodiment in all other respects, and like reference numerals are used for like portions with descriptions thereof omitted.

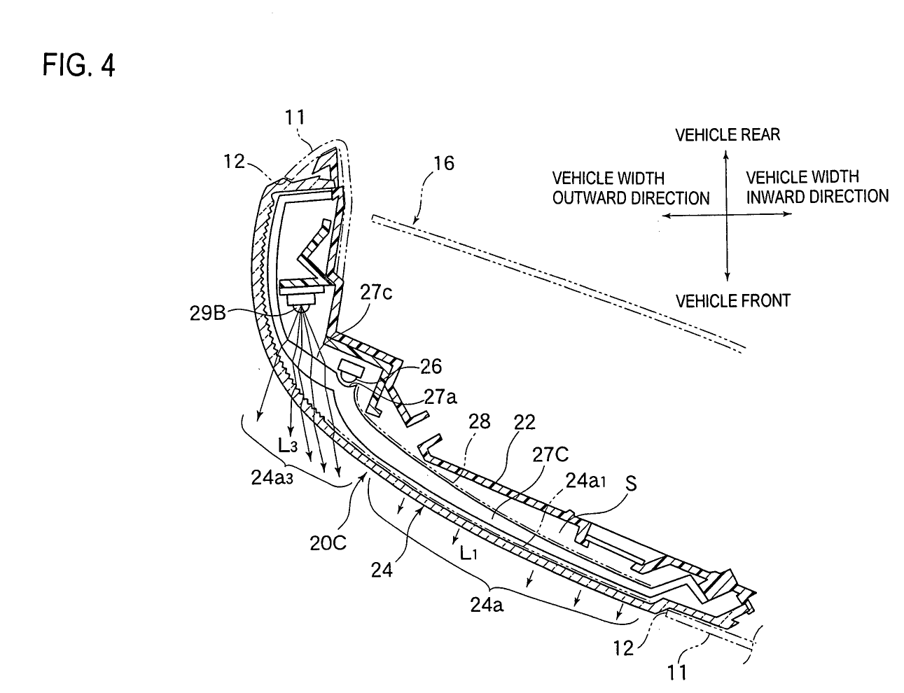

FIG. 4 shows, in cross-section, a marker lamp according the third embodiment of the present invention.

In the first and second embodiments, the present invention is described with reference to an integrated side turn signal lamp/daytime running lamp in which a daytime running lamp and a side turn signal lamp are integrated. In the third embodiment, the present invention is applied to a daytime running lamp 20C.

In this daytime running lamp 20C, a light guide inner lens 27C is disposed in the lamp chamber space S defined by the lamp body 22 and the front lens 24. The light guide inner lens 27C extends up to the position of an end portion on the side of the lamp chamber space S that wraps around toward the vehicle backward direction.

Inside the lamp chamber space S, an LED 26 that emits white light is disposed to face the vehicle forward direction and also to face the incident light end portion 27a of the light guide inner lens 27C. An LED 29B that emits white light is disposed to face the vehicle forward direction at a position adjacent to the LED 26 in the vehicle width outward direction, namely, behind the light guide inner lens 27C.

The light guide inner lens 27C is formed with a light refraction portion 27c at the area that faces the LED 29B. The light refraction portion 27c has a flat surface on its incident side and a curved surface on its emission side. In addition to the light emitted from the surface of the light guide inner lens 27C as a result of light emitted from the LED 26, such a light distribution is achieved that light emitted from the LED 29B is transmitted by the light refraction portion 27c in the vehicle forward direction as light L₃ with a strong orientation characteristic.

More specifically, the majority of the light emitted from the LED 29B is transmitted through and refracted by the light refraction portion 27c of the light guide inner lens 27C. Such light is subsequently distributed with a strong orientation characteristic in the vehicle forward direction through the light emission area 24a3 of the front lens 24. Furthermore, a part of the light emitted from the LED 29B, which is incident to the light refraction portion 27c of the light guide inner lens 27C, is guided into the light guide inner lens 27C along with the light emitted from the LED 26 that is incident from the incident light end portion 27a. As a result, the entire surface of the light guide inner lens 27C toward the vehicle width inward direction (an area of the light guide inner lens 27C with the stipples 28 formed thereon) is illuminated, and the light emission area 24a (the area that faces the area of the light guide inner lens 27C planarly emitting light) of the front lens 24 emits light.

In this third embodiment, all of the light emission areas 24a and 24a3 of the front lens 24 emit light and naturally have a large light-emitting surface area. However, the light L₃ emitted in the vehicle forward direction from the light emission area 24a3 of the front lens 24 has a stronger orientation characteristic (directionality) compared to the light distribution L₁ which is in the vehicle forward direction and by the light emitted via the surface of the light guide inner lens 27C (light emission area 24a of the front lens 24). This increased strength consequently increases the amount of light distribution in the vehicle forward direction and improves the visibility of the lamp from the vehicle forward direction.

Aluminizing is performed on the back surface of the light guide inner lens 27C excluding the light refraction portion 27c and incident light end portion 27a, so that the entire lamp chamber interior appears as a mirrored surface and so that the area behind the light guide inner lens 27C is not visible through the lens 27C.

The third embodiment is otherwise identical to the above-described first and second embodiments in all respects, and like reference numerals are used for like portions with descriptions thereof omitted.

In the third embodiment, an opening can be formed in an area (the light refraction portion 27c) that faces the LED 29B of the light guide inner lens 27C. With this structure, the light emitted from the LED 29B is directly guided to the front lens 24 without allowing the light to pass through the light guide inner lens 27C.

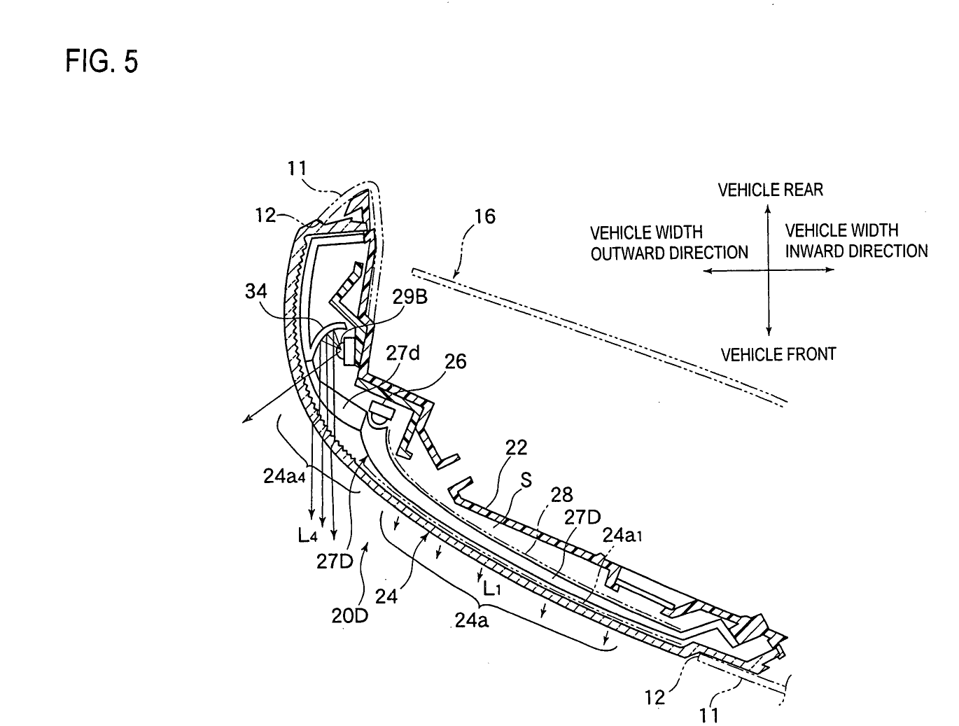

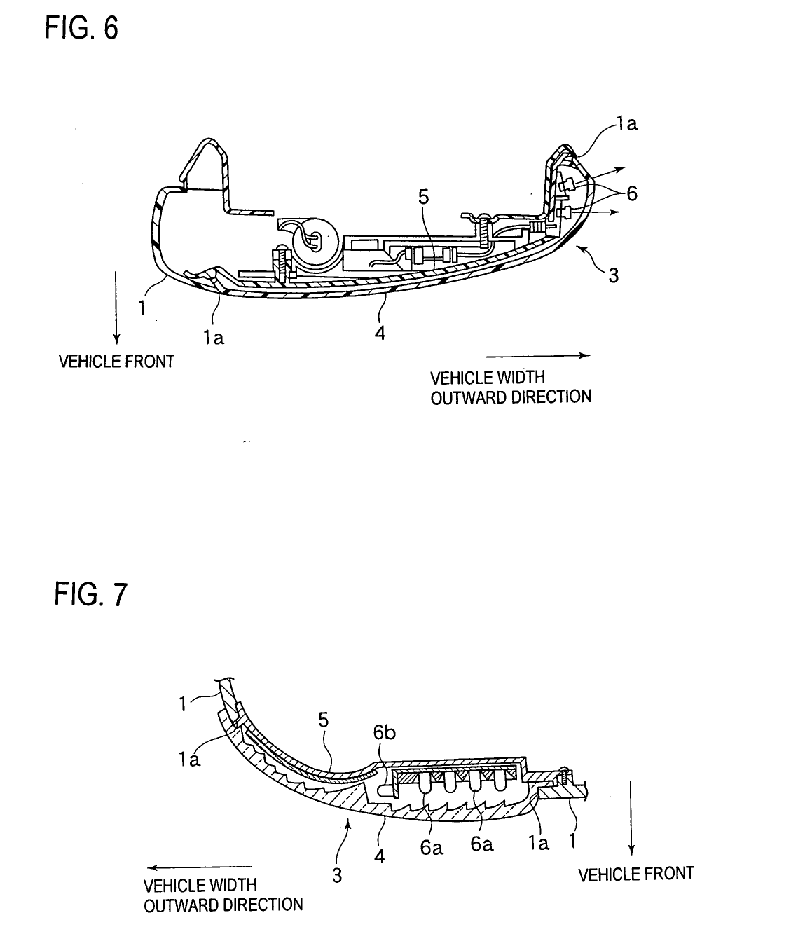

FIG. 5 shows, in cross-section, a marker lamp according to the fourth embodiment of the present invention.

In the daytime running lamp 20C of the third embodiment, the light emitted from the LED 29B is distributed in the vehicle forward direction directly or via the light refraction portion 27c of the light guide inner lens 27C. In the daytime running lamp 20D of the fourth embodiment shown in FIG. 5, light emitted from the LED 29B is distributed in the vehicle forward direction via a reflector 34 whose surface is aluminized.

More specifically, the LED 29B is disposed to face the vehicle width outward direction. The reflector 34 is integrated with a light guide inner lens 27D and disposed in front of the LED 29B. Light emitted from the LED 29B is, as a result, reflected in the vehicle forward direction by the reflector 34, resulting in the formation of light distribution L₄ with a strong orientation characteristic in the vehicle forward direction. In other words, the light guide inner lens 27D is formed with a light refraction portion 27d at a position that faces the reflector 34; and light emitted from the LED 29B and reflected by the reflector 34 passes through the light refraction portion 27d and is distributed from the light emission area 24a4 in the form of light L₄ that has a strong orientation characteristic in the vehicle forward direction.

The fourth embodiment is otherwise identical to the third embodiments in all respects, and like reference numerals are used for like portions with descriptions thereof omitted.

The daytime running lamps 20C and 20D described above and shown in FIG. 4 and FIG. 5, respectively, are turned ON when the engine switch is turned ON and turned OFF when the engine switch is turned OFF or a clearance switch is turned ON. However, an LED that emits light of a predetermined color other than red, such as blue or green, can be used for the LEDs 26 and 29B. With use of such an LED of blue or green, the daytime running lamps 20C and 20D can also be used as fashion lamps during nighttime running by way of designing the daytime running lamps 20C and 20D so that they stay lit as long as the engine switch is not turned OFF, regardless of whether the clearance lamp switch is turned ON.

In the first embodiment, the LED 26 emits white light, and the LED 29 (29B) emits amber light; and in the second embodiment, the front lens 24 is a two-colored lens 24B so that the light emission area 24a is transparent and the light emission area 24a is amber in color. However, the first embodiment can be designed so that an amber-colored filter (including a cap) is interposed in front of an LED 29 that emits white light so that the light emission area 24b of the transparent front lens 24 emits amber light.

Furthermore, the third and fourth embodiments can be designed so that the light guide inner lenses 27C and 27D respectovely assume a predetermined color, such as blue and green, other than red. With this structure, white light emitted by the LEDs 26 and 29B is subsequently emitted in a predetermined color, such as blue or green, other than red, through the light emission areas 24a and 24b of the transparent front lens 24.

1. A vehicular lamp adapted to be installed in a mirror housing of a vehicle, wherein
said mirror housing includes therein a sideview mirror main body and has a laterally extending opening formed on an end side, which wraps around toward a vehicle backward direction, of an outer wall of said mirror housing; and
a lamp main body of said vehicular lamp is formed by a lamp body and a front lens, said lamp main body having a curved shape that generally follows the curved opening of the mirror housing, and said front lens being substantially flush with and exposed through the opening; and wherein
said vehicular lamp has a curved, horizontally elongated lamp chamber space which is defined by the lamp body and front lens and is provided therein with:
a light guide inner lens disposed along the front lens which planarly emits light, and
a light source for said vehicular lamp;
wherein said light source comprises:
a first LED provided to face a vehicle forward direction on a curved wrap-around side of the lamp chamber space and to face an incident light end portion of the light guide inner lens, said wrap-around side corresponding to a vehicle width outward direction,; and
a second LED that is disposed adjacent to the first LED in the vehicle width outward direction for distributing light in a predetermined direction directly or via a reflector.

2. The vehicular lamp according to claim 1, wherein said front lens emits light of different colors by a means selected from the group consisting of:
a plurality of LEDs that emit light of different colors,
a colored filter disposed in front of at least one of the first and second LEDs,
a light guide inner lens of a plurality of different colors, and
a front lens having a plurality of light emission areas of different colors.

3. The vehicular lamp according to claim 2, further comprising a partition provided between the first and second LEDs in the lamp chamber space for preventing mixing of colors of emitted light in the first and second light emission areas of the front lens.

4. The vehicular lamp according to claim 3, further comprising:
a vertical groove formed in the front lens, said vertical groove extending in a vertical direction with respect to the partition and being provided between the first and second light emission areas on the front lens; and
a vertical rib provided in the opening of the outer wall of the mirror housing, said vertical rib extending to vertically traverse the opening and engaging with the vertical groove of the front lens.
